(19) United States
(12) Patent Application Publication
(10) Pub. No.: US 2023/0400820 A1
(43) Pub. Date: Dec. 14, 2023

(54) CONTROL DEVICE, CONTROL SYSTEM, CONTROL METHOD, AND COMPUTER READABLE MEDIUM STORING CONTROL PROGRAM

(71) Applicant: Mitsubishi Electric Corporation, Tokyo (JP)

(72) Inventor: Tadashi ONISHI, Tokyo (JP)

(73) Assignee: Mitsubishi Electric Corporation, Tokyo (JP)

(21) Appl. No.: 18/238,337

(22) Filed: Aug. 25, 2023

Related U.S. Application Data
(63) Continuation of application No. PCT/JP2021/009708, filed on Mar. 11, 2021.

(51) Int. Cl. G05B 13/02

(52) U.S. Cl. CPC G05B 13/0265

(57) ABSTRACT

A control device capable of more appropriately learning a control detail of a control target in accordance with a state of the control target is provided. A control device according to the present disclosure includes a state data acquisition unit to acquire state data indicating a state of a control target, a state category identification unit to identify a state category to which a state indicated by the state data belongs among a plurality of state categories indicating classifications of states of the control target on the basis of the state data, a reward generation unit to calculate a reward value of a control detail for the control target on the basis of the state category and the state data, and a control learning unit to learn the control detail on the basis of the state data and the reward value.

### CROSS REFERENCE TO RELATED APPLICATION

This application is a Continuation of PCT International Application No. PCT/JP2021/009708, filed on Mar. 11, 2021, which is hereby expressly incorporated by reference into the present application.

### TECHNICAL FIELD

The present disclosure relates to a control device, a learning device, an inference device, a control system, a control method, a learning method, an inference method, a control program, a learning program, and an inference program.

### BACKGROUND ART

A control device that performs machine learning on an action to be taken by a control target such as a vehicle or a conveying machine and outputs a control detail on the basis of a result of the machine learning has been studied.

For example, Patent Document 1 discloses a technique for learning a state and a speed of a conveying machine in association with each other by reinforcement learning to appropriately control an action of the conveying machine.

### CITATION LIST

Patent Document
Patent Document 1: Japanese Patent Application Publication Laid-open, No. 2019-34836

### SUMMARY OF INVENTION

### Problems to be Solved by Invention

However, in the technique of Patent Document 1, a reward value given by reinforcement learning is given as a constant value (+1 or −1) determined by a single rule, and in a case where the state of the control target is divided into a plurality of states, and the reward changes to be high or low depending on each state, an appropriate reward cannot be given. As a result, a problem arises in that the control detail for the control target cannot be learned appropriately.

The present disclosure has been made to solve the above-described problem and to provide a control device capable of more properly learning the control detail of a control target in accordance with a state of the control target.

### Means for Solving Problems

A control device according to the present disclosure includes a state data acquisition unit to acquire state data indicating a state of a control target, a state category identification unit to identify a state category to which a state indicated by the state data belongs among a plurality of state categories indicating classifications of states of the control target on the basis of the state data, a reward generation unit to calculate a reward value of a control detail for the control target on the basis of the state category and the state data, and a control learning unit to learn the control detail on the basis of the state data and the reward value. The reward generation unit includes a reward calculation formula selection unit to select a reward calculation formula different for each of the plurality of state categories on the basis of the inputted state category, and a reward value calculation unit to calculate the reward value using the reward calculation formula selected by the reward calculation formula selection unit.

### Effect of Invention

The control device according to the present disclosure includes the state category identification unit to identify a state category to which a state indicated by the state data belongs among a plurality of state categories indicating classifications of states of the control target on the basis of the state data, the reward generation unit to calculate a reward value of a control detail for the control target on the basis of the state category and the state data, and the control learning unit to learn the control detail on the basis of the state data and the reward value. Therefore, even when the reward changes to be high or low in accordance with a plurality of possible states that the control target takes, the control detail can be learned more appropriately by calculating the reward value on the basis of the state category.

### BRIEF DESCRIPTION OF DRAWINGS

FIG. 1 is a configuration diagram showing a configuration of a control device 100 according to Embodiment 1.

FIG. 2 is a configuration diagram showing a configuration of a reward generation unit 130 according to Embodiment 1.

FIG. 3 is a conceptual diagram for explaining a specific example of processing of a reward calculation formula selection unit 131 according to Embodiment 1.

FIG. 4 is a hardware configuration diagram showing a hardware configuration of the control device 100 according to Embodiment 1.

FIG. 5 is a flowchart showing an operation of the control device 100 according to Embodiment 1.

FIG. 6 is a configuration diagram showing a configuration of a control system 2000 according to Embodiment 2.

FIG. 7 is a configuration diagram showing a configuration of a reward generation unit 230 according to Embodiment 2.

FIG. 8 is a flowchart showing an operation of a learning device 300 according to Embodiment 2.

FIG. 9 is a flowchart showing an operation of an inference device 400 according to Embodiment 2.

### MODES FOR CARRYING OUT INVENTION

### Embodiment 1

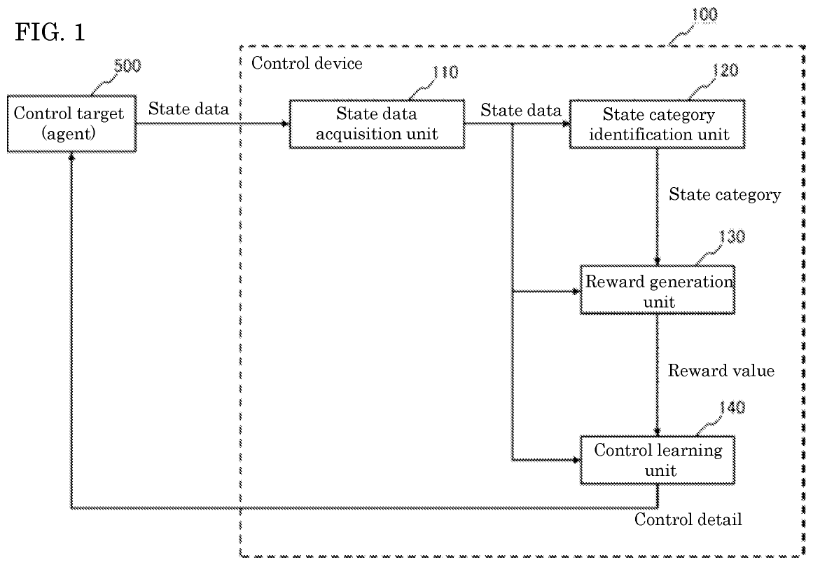

FIG. 1 is a configuration diagram illustrating a configuration of a control device 100 according to Embodiment 1. The control device 100 observes a state of a control target 500 that is an agent and controls the control target 500 by determining an appropriate action in accordance with the state.

The control target 500 performs an action on the basis of a control detail inputted from the control device 100, and is, for example, an automated vehicle, a character of a computer game, or the like. Here, the control target 500 may be an actual machine or may be a machine reproduced by a simulator.

The control device 100 includes a state data acquisition unit 110, a state category identification unit 120, a reward generation unit 130, and a control learning unit 140.

The state data acquisition unit 110 acquires state data indicating a state of a control target. More specifically, for example, when the agent is a vehicle, the state data acquisition unit 110 acquires, as the state data, vehicle state data including the position and speed of the vehicle, and further, when the agent is, for example, a character of a computer game such as a first player shooter (FPS) game or a strategic game, it acquires character state data indicating the position of the character. The vehicle state data may include information indicating posture, etc. in addition to the position and speed of the vehicle, and similarly, the character state data may include information indicating the speed and posture of the character and an attribute of the character in the game, and the like, in addition to the position of the character, and an image of the character's field of view or a bird's-eye view, etc. may also be used as the vehicle state data.

Further, the state data acquisition unit 110 may be implemented by a communication device that acquires state data from a sensor such as a camera provided in the control target or may be implemented by a sensor itself that monitors the control target. In addition, when state data of a character in a computer game is acquired, a processor that executes the computer game and a processor for the state data acquisition unit 110 may be implemented by a single processor.

The state category identification unit 120 identifies, on the basis of the state data, a state category to which the state indicated by the state data belongs among a plurality of state categories indicating classification of states of the control target. Here, the state category is obtained by classifying states of the control target into a plurality of categories, and a state of the control target belongs to one of the state categories set in advance. More specifically, for example, when the control target is a vehicle, a

designer sets in advance state categories such as the vehicle traveling straight, the vehicle turning right, the vehicle changing lanes, and the vehicle being parked. For example, when the control target is a character of a computer game, particularly a strategic game in which the character fights against an enemy character, whether or not the character recognizes the enemy character is set as a state category.

Furthermore, the state category may be set manually or may be set by collecting state data in advance and classifying the states indicated by the state data by machine learning such as logistic regression and a support vector machine.

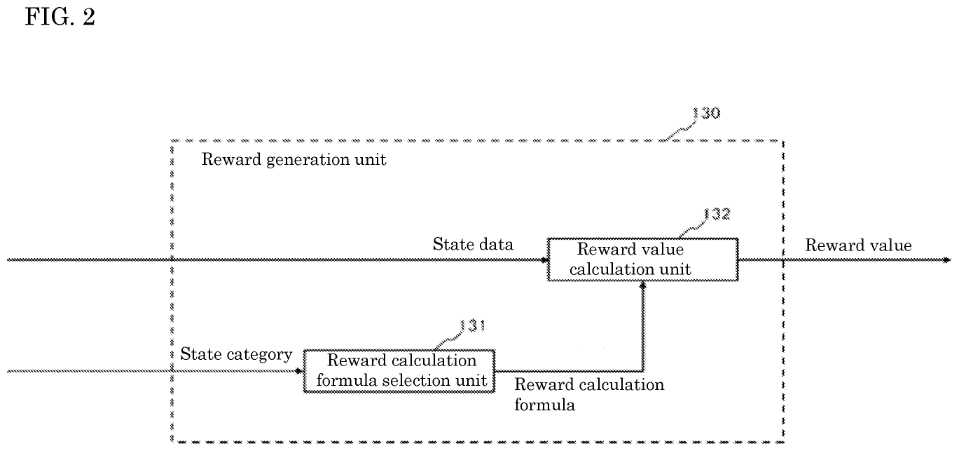

The reward generation unit 130 calculates a reward value of the control detail for the control target on the basis of the state category and the state data. As shown in FIG. 2, in Embodiment 1, the reward generation unit 130 includes a reward calculation formula selection unit 131 and a reward value calculation unit 132.

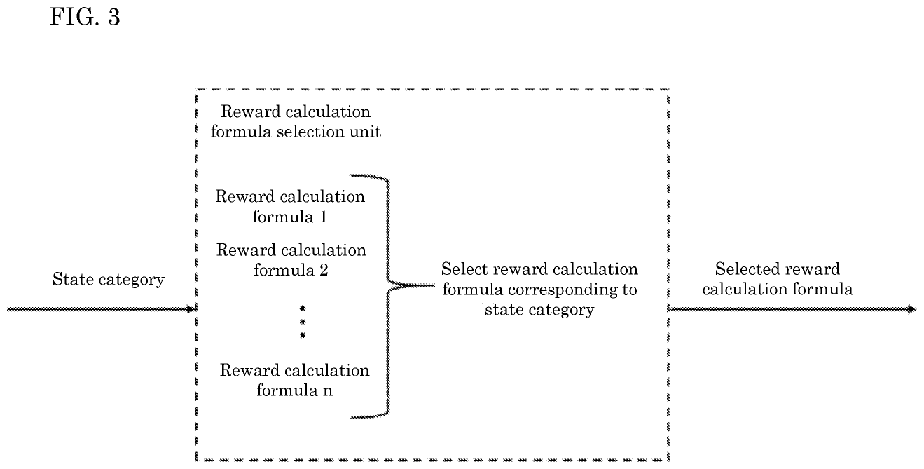

The reward calculation formula selection unit 131 selects a reward calculation formula to be used for calculation of a reward value on the basis of the inputted state category. A specific example of processing performed by the reward calculation formula selection unit 131 will be described with reference to FIG. 3. FIG. 3 is a conceptual diagram for explaining processing of the reward calculation formula selection unit 131.

In a fighting type strategic game, a state category 1 is a state in which a character of the agent does not observe an enemy character, and a state category 2 is a state in which the character has observed the enemy character. In the state category 1, the designer sets in advance a reward calculation formula 1 for the character moving so as to search for the location of the opponent, and in the state category 2, the designer sets in advance a reward calculation formula 2 for the character following the opponent (shortening the distance to the opponent). Here, the reward calculation formula for the character moving so as to search for the location of the opponent is a reward calculation formula for increasing the reward value when an action for searching for the location of the opponent is taken, and the reward calculation formula for the character following the opponent is a reward calculation formula for increasing the reward value when an action for following the opponent is taken.

Then, the reward calculation formula selection unit 131 selects the reward calculation formula 1 when the inputted state category is the state category 1 and selects the reward calculation formula 2 when the inputted state category is the state category 2.

In addition, in a case where an automated vehicle is the control target, when a lane change on an expressway is taken as an example, the state category 1 is the state before the lane change, the state category 2 is the state during the lane change, and the state category 3 is the state after the lane change. In the state category 1, a reward calculation formula 1 that urges an ego-vehicle to accelerate in the lane can be set, in the state category 2, a reward calculation formula 2 can be set in which the ego-vehicle is urged to change the lane while maintaining a sufficient distance from another vehicle traveling in the right lane, and in the state category 3, a reward calculation formula 3 that urges the ego-vehicle to accelerate so as to increase the distance from another vehicle traveling behind can be set.

The reward calculation formula for urging the ego-vehicle to accelerate in the lane is a reward calculation formula for increasing the reward value when the ego-vehicle takes an action of accelerating in the lane. The reward calculation formula for urging the ego-vehicle to change the lane while the ego-vehicle keeps a sufficient distance from another vehicle traveling in the right lane is a reward calculation formula for increasing the reward value when the ego-vehicle takes an action of changing the lane while the ego-vehicle keeps a sufficient distance from another vehicle traveling in the right lane, and the reward calculation formula that urges the ego-vehicle to accelerate so as to increase the distance from another vehicle traveling behind is a reward calculation formula for increasing the reward value when the ego-vehicle takes an action to accelerate so as to increase the distance from another vehicle traveling behind.

The reward value calculation unit 132 calculates a reward value using a reward calculation formula selected by the reward calculation formula selection unit 131. For example, when the reward calculation formula selection unit 131 selects the reward calculation formula 1, the reward value calculation unit 132 substitutes a value indicated by the state data into the reward calculation formula 1 to calculate a reward value.

The control learning unit 140 learns the control detail on the basis of the state data and the reward value, and further the control learning unit 140 outputs the control detail, that is, an action to be performed next by the control target on the basis of the state data and the reward value. The learning here means optimization of the control detail based on the reward value, and as a learning method, for example, a reinforcement learning method such as Monte Carlo tree search (MCTS) or Q-learning can be used, or an algorithm other than the above may be used as long as the algorithm optimizes the control detail using the reward value.

For example, more specifically, the control learning unit 140 updates a value function indicating a value of the action of the control target using the inputted reward value, and the control learning unit 140 outputs a control detail on the basis of the updated value function and a measure determined in advance by the designer. Here, the update of the value function does not need to be performed every time and may be performed at an update timing set according to an algorithm used for the learning.

Specific examples of the control detail include the speed and posture of a vehicle when the control target is the vehicle, and the speed and posture of a character and other selectable actions in the game when the control target is the character in a computer game.

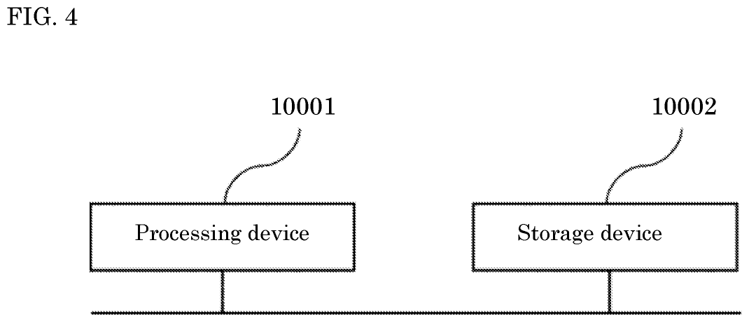

Next, a hardware configuration of the control device 100 according to Embodiment 1 will be described. FIG. 4 is the hardware configuration of the control device 100 according to Embodiment 1.

The hardware shown in FIG. 4 includes a processing device 10001 such as a central processing unit (CPU), a read only memory (ROM), and a storage device 10002 such as a hard disk.

Each function of the control device 100 shown in FIG. 1 is implemented by the processing device 10001 executing a program stored in the storage device 10002. Further, a method to implement each of the functions is not limited to a combination of the above-described hardware and the program, and it may be implemented by a single hardware unit such as a large scale integrated circuit (LSI) in which a program is implemented in a processing device. Alternatively, a part of the functions may be implemented by dedicated hardware and a part of the functions may be implemented by a combination of a processing device and a program.

In addition, the control device 100 may be formed integrally with the control target 500 or may be implemented by a server or the like and configured to remotely control the control target 500.

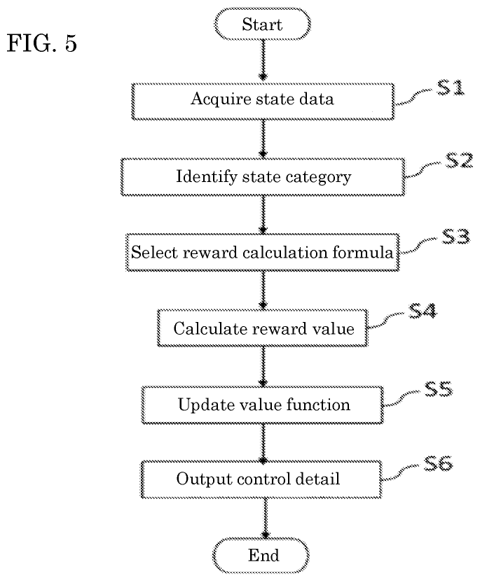

Next, an operation of the control device 100 according to Embodiment 1 will be described. FIG. 5 is a flowchart illustrating an operation of the control device 100 according to Embodiment 1. Here, the operation of the control device 100 corresponds to a control method, and a program that causes a computer to execute the operation of the control device 100 corresponds to a control program. In addition, “unit” may be read as “step” as appropriate.

First, in step S1, the state data acquisition unit 110 acquires the state data from the control target itself or a sensor that monitors the state of the control target.

Next, in step S2, the state category identification unit 120 identifies a state category to which the state indicated by the state data acquired in step S1 belongs.

Next, in step S3, the reward calculation formula selection unit 131 selects a reward calculation formula to be used for calculation of a reward value on the basis of the state category identified in step S3.

Next, in step S4, the reward value calculation unit 132 calculates a reward value using the reward calculation formula selected in step S3.

Next, in step S5, the control learning unit 140 updates the value function on the basis of the reward value calculated in step S4.

Next, in step S6, the control learning unit 140 determines the control detail for the control target on the basis of the updated value function and the measure, and outputs the determined control detail to the control target, and finally, the control target executes the action indicated by the inputted control detail.

Although only one loop of the operation of the control device 100 from step S1 to step S6 has been described, the control device 100 optimizes the control detail by repeatedly executing the operation from step S1 to step S6.

By the operation as described above, the control device 100 according to Embodiment 1 calculates the reward value on the basis of the state category and learns the control detail of the control target on the basis of the reward value. Therefore, it is possible to more appropriately learn the control detail.

More specifically, since the states of the control target are classified into the plurality of state categories and a reward is calculated using a reward calculation formula different for each state category, it is possible to appropriately learn the control detail by calculating a reward value using a reward calculation formula suitable for each state.

### Embodiment 2

A control device 200 according to Embodiment 2 and a control system 2000 including the control device 200 as a part thereof will be described.

Although the configuration in which the optimization and output of the control detail are performed only by the control device 100 has been described in Embodiment 1, it is possible to reduce the calculation time for the optimum solution calculation by combining an optimum solution obtained by the control device 100 as training data with supervised learning.

In Embodiment 2, a configuration with the combination with the supervised learning will be described.

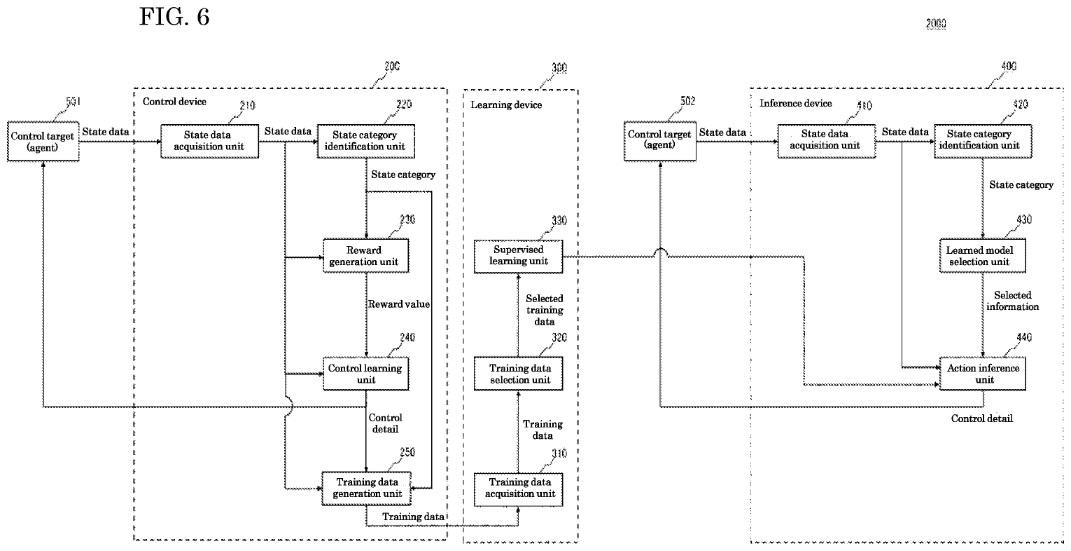

FIG. 6 is a configuration diagram illustrating a configuration of a control system 2000 according to Embodiment 2. The control system 2000 includes a control device 200, a learning device 300, and an inference device 400.

The control device 200 has the same basic functions as those of the control device 100 according to Embodiment 1 but has a function of generating training data to be used for the supervised learning in addition to the functions of the control device 100. Here, the training data generated by the control device 200 is data in which state data indicating a state of the control target and a control detail of the control target are paired. The learning device 300 performs the supervised learning using the training data generated by the control device 200 and generates a supervised learned model for inferring a control detail from the state data.

The inference device 400 infers a control detail from the inputted state data using the supervised learned model generated by the learning device 300 and controls the control target on the basis of the inferred control detail.

Details of the control device 200, the learning device 300, and the inference device 400 will be described below.

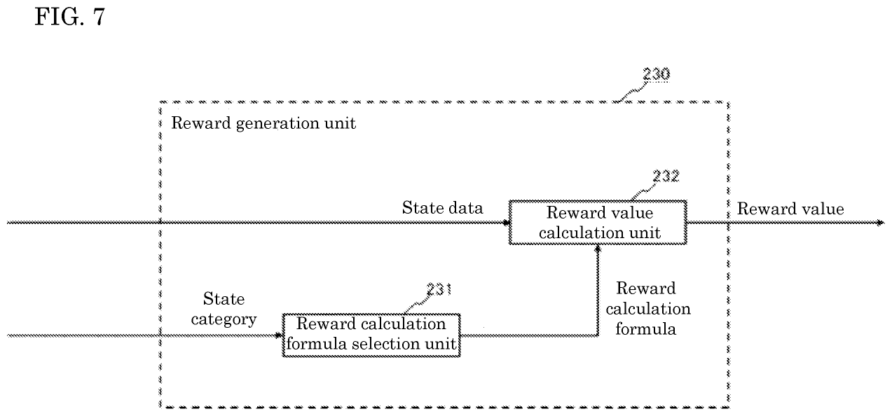

The control device 200 includes a state data acquisition unit 210, a state category identification unit 220, a reward generation unit 230, a control learning unit 240, and a training data generation unit 250. As illustrated in FIG. 7, as with the case in Embodiment 1, the reward generation unit 230 includes a reward calculation formula selection unit 231 and a reward value calculation unit 232.

Functional units other than the training data generation unit 250 are the same as those in the configuration of the control device 100 according to Embodiment 1. The training data generation unit 250 generates training data in which state data and a control detail are associated with each other. The training data generation unit 250 acquires state data from the state data acquisition unit 210 and acquires a control detail from the control learning unit 240. Here, the control detail of the control target used as the training data by the training data generation unit 250 is the control detail after the learning in the control learning unit 240 is finished, that is, the control detail as an optimum solution.

In addition, the training data generation unit 250 acquires a state category to which a state indicated by the state data included in the training data belongs, from the state category identification unit 220, and stores the state category in association with the training data.

A timing at which the training data generation unit 250 generates the training data may be such that the training data is generated together with the input of the state data and the output of the control detail after the optimization of the control detail is completed, or the state data and the control detail are stored for a predetermined period of time and the training data is generated collectively as post-processing after the data is accumulated.

The learning device 300 includes a training data acquisition unit 310, a training data selection unit 320, and a supervised learning unit 330.

The training data acquisition unit 310 acquires training data including the state data indicating the state of the control target and the control detail of the control target, and the state category to which the state indicated by the state data belongs. The training data acquisition unit 310 acquires the training data and the state categories from the training data generation unit 250 included in the control device 200.

The training data selection unit 320 selects learning data to be used for learning from the training data inputted from the control device 200. As a selection method, for example, in the case of a computer game, when a character A and a character B fight against each other, if only the character

B is desired to be strengthened, only data when the character B won is selected as the training data, and in the example of autonomous driving, only data when driving without collision with another vehicle was able to be performed is selected as the training data.

When all data are used as the learning data, the training data selection unit 320 may select all training data inputted from the control device 200 as the learning data.

The supervised learning unit 330 selects a supervised learning model in accordance with a state category, performs learning of the supervised learning model using the training data, and generates a supervised learned model for inferring a control detail of the control target from the state of the control target.

More specifically, for example, in a computer game, in a case where low-dimensional information such as position information and speed information of an opponent is input and an action of the next step is to be an output, a machine learning method such as gradient boosting can be used.

Furthermore, in an example of autonomous driving or a conveying machine, in a case where a steering angle and a speed of the next step are output when as an image captured ahead of the ego-vehicle or a bird's-eye view image is an input in addition to the position and speed information of the ego-vehicle and another vehicle, a convolutional neural network (CNN) can be used.

Here, the supervised learning unit 330 may generate a supervised learned model using a different algorithm for each state category. For example, in an example of lane change of an automated vehicle traveling on an expressway, it is possible to use a machine learning method having a high calculation speed with only position and speed information of the ego-vehicle and another vehicle as inputs for the state categories 1 and 3, and to use a deep learning model having a high inference performance with an image ahead of the vehicle and a bird's-eye view image as inputs for the state category 2.

The inference device 400 includes a state data acquisition unit 410, a state category identification unit 420, a learned model selection unit 430, and an action inference unit 440.

Similar to the state data acquisition unit 210, the state data acquisition unit 410 acquires state data indicating a state of the control target.

Similar to the state category identification unit 220, the state category identification unit 420 identifies, on the basis of the state data, a state category to which the state of the control target belongs among the plurality of state categories indicating the classification of the state of the control target.

The learned model selection unit 430 selects a supervised learned model for outputting a control detail of the control target from the state data on the basis of the state category identified by the state category identification unit 420. For example, the learned model selection unit 430 stores a table in advance in which the state category is associated with the supervised learned model, selects a supervised learned model corresponding to the inputted state category using the table, and outputs information indicating the selected supervised learned model to the action inference unit 440 as selected information.

The action inference unit 440 outputs a control detail on the basis of the state data using the supervised learned model selected by the learned model selection unit 430. Here, the action inference unit 440 acquires and stores the supervised learned model in advance from the supervised learning unit 330 included in the learning device 300, and the action inference unit 440 calls the supervised learned model corresponding to the identified state category from among the stored supervised learned models on the basis of the selection information inputted from the learned model selection unit 430 and performs inference of a control detail.

Next, hardware configurations of the control device 200, the learning device 300, and the inference device 400 will be described. Similar to the control device 100, each function of the control device 200, the learning device 300, and the inference device 400 is implemented by executing a program stored in a storage device such as a ROM or a hard disk by a processing device such as a CPU. Here, the control device 200, the learning device 300, and the inference device 400 may use a common processing device and a common storage device or may use different processing devices and different storage devices for each of them. Further, a method to implement each of the functions is not limited to a combination of the above-described hardware and the program, and it may be achieved by a single hardware unit such as a large scale integrated circuit (LSI) in which a program is implemented in a processing device. Alternatively, a part of the functions may be implemented by dedicated hardware and a part of the functions may be implemented by a combination of a processing device and a program.

The control system 2000 according to Embodiment 2 is configured as described above.

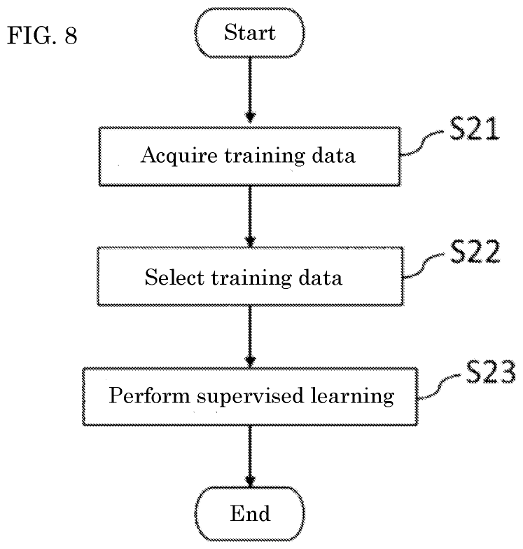

Next, an operation of the learning device 300 will be described. FIG. 8 is a flowchart showing the operation of the learning device 300 according to Embodiment 2.

Here, the operation of the learning device 300 corresponds to a learning method, and a program that causes a computer to execute the operation of the learning device 300 corresponds to a learning program. In addition, “unit” may be read as “step” as appropriate.

First, in step S21, the training data acquisition unit 310 acquires training data and state categories associated with the training data from the control device 200.

Next, in step S22, the training data selection unit 320 selects training data to be actually used for learning from among the training data acquired in step S21. When the selection of the training data is not necessary, the process of step S22 may be omitted.

Finally, in step S23, the supervised learning unit 330 performs supervised learning for each state category using the training data selected in step S22 and generates a supervised learned model for each state category.

Through the operations described above, the learning device 300 can generate supervised learned models applicable to the inference of control details in a plurality of states of the control target.

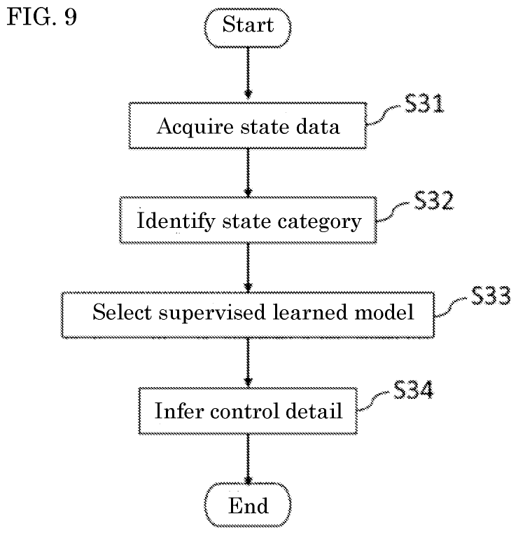

Next, an operation of the inference device 400 will be described. FIG. 9 is a flowchart illustrating an operation of the inference device 400 according to Embodiment 2.

Here, the operation of the inference device 400 corresponds to an inference method, and a program that causes a computer to execute the operation of the inference device 400 corresponds to an inference program. In addition, “unit” may be read as “step” as appropriate.

First, in step S31, the state data acquisition unit 410 acquires state data from the control target itself or the sensor that monitors the state of the control target.

Next, in step S32, the state category identification unit 420 identifies a state category to which a state indicated by the state data acquired in step S31 belongs.

Next, in step S33, the learned model selection unit 430 selects a supervised learned model corresponding to the state category identified in step S32.

Finally, in step S34, the action inference unit 440 infers a control detail from the state data using the supervised learned model selected in step S33. Then, the action inference unit 440 transmits the inferred control detail to the control target, and the inference device 400 ends the operation.

Through the above-described operations, the inference device 400 can output control details in accordance with the plurality of states that the control target can take, by inferring a control detail using the supervised learned model corresponding to each state category.

When the control detail is learned by using an algorithm such as MCTS as in the control device 100 according to Embodiment 1, a solution is calculated from a condition in which data accumulation is not performed. Therefore, it takes a certain time to calculate an optimum solution.

However, in the control system 2000 according to Embodiment 2, it is possible to shorten the calculation time for an optimum solution by storing the data of the optimum solution obtained by the training data generation unit 250, and then performing the supervised learning in the learning device 300 to output a solution in the inference device 400. In addition, in a case where a plurality of supervised learning models corresponding to state categories are created in the supervised learning unit 330, it is possible to shorten the inference time by using only a supervised learned model necessary at the time of inference.

Finally, a variation example of the control system 2000 will be described. Although the supervised learning unit 330 performs the supervised learning for all the state categories in the above description, the supervised learning may be performed only for some of the state categories and the learning method and the control method according to Embodiment 1 may be used for the remaining state categories.

For example, in the example of the lane change on the highway of an automated vehicle described in Embodiment 1, the difficulty level during lane change of state category 2 is higher than that of other state categories, and it is difficult to calculate an optimum solution. In such a case, only the state category 2 may use the supervised learning to learn an optimum solution, and the learning method of Embodiment 1 may be used for the other state categories.

Furthermore, although the supervised learning unit 330 performs learning of a different supervised learning model for each state category, in a case where the plurality of state categories can be handled by one supervised learning model, only one supervised learning model may be learned for those state categories. In addition, in a case where only one supervised learning model is learned for all categories, the inference device 400 may omit the processing of the learned model selection unit 430.

### INDUSTRIAL APPLICABILITY

The control device and the control system according to the present disclosure are suitable for use in controlling an automated vehicle, a conveying machine, and a computer game.

### DESCRIPTION OF REFERENCE NUMERALS AND SIGNS

100, 200: control device, 110, 210: state data acquisition unit, 120, 220: state category identification unit, 130, 230: reward generation unit, 131, 231: reward calculation formula selection unit, 132, 232: reward value calculation unit, 140, 240: control learning unit, 250: training data generation unit, 300: learning device, 310: training data acquisition unit, 320: training data selection unit, 330: supervised learning unit, 400: inference device, 410: state data acquisition unit, 420: state category identification unit, 430: learned model selection unit, 440: action inference unit, 500, 501, 502: control target

1. A control device comprising:
state data acquisition circuitry to acquire state data indicating a state of a control target;
state category identification circuitry to identify a state category to which a state indicated by the state data belongs among a plurality of state categories indicating classifications of states of the control target on the basis of the state data;
reward generation circuitry to calculate a reward value of a control detail for the control target on the basis of the state category and the state data; and
control learning circuitry to learn the control detail on the basis of the state data and the reward value, wherein
the reward generation circuitry includes reward calculation formula selection circuitry to select a reward calculation formula different for each of the plurality of state categories on the basis of the inputted state category, and
reward value calculation circuitry to calculate the reward value using the reward calculation formula selected by the reward calculation formula selection circuitry.

2. The control device according to claim 1, further comprising training data generation circuitry to generate training data in which the state data and the control detail are associated with each other.

3. The control device according to claim 1, wherein
the control target is a vehicle, and
the state data acquisition circuitry acquires vehicle state data including a position and a speed of the vehicle as the state data.

4. The control device according to claim 2, wherein
the control target is a vehicle, and
the state data acquisition circuitry acquires vehicle state data including a position and a speed of the vehicle as the state data.

5. The control device according to claim 1, wherein
the control target is a character of a computer game, and
the state data acquisition circuitry acquires character state data including a position of the character as the state data.

6. The control device according to claim 2, wherein
the control target is a character of a computer game, and
the state data acquisition circuitry acquires character state data including a position of the character as the state data.

7. A control system comprising:
state data acquisition circuitry to acquire state data indicating a state of a control target;
state category identification circuitry to identify a state category to which a state indicated by the state data belongs among a plurality of state categories indicating classifications of states of the control target on the basis of the state data;
reward generation circuitry to calculate a reward value of a control detail for the control target on the basis of the state category and the state data;
control learning circuitry to learn the control detail on the basis of the state data and the reward value;
training data generation circuitry to generate training data in which the state data and the control detail are associated with each other;
supervised learning circuitry to generate a supervised learned model for inferring the control detail from the state data on the basis of the training data generated by the training data generation circuitry; and
action inference circuitry to infer the control detail using the supervised learned model,
wherein
the reward generation circuitry includes reward calculation formula selection circuitry to select a reward calculation formula different for each of the plurality of state categories on the basis of the inputted state category, and
reward value calculation circuitry to calculate the reward value using the reward calculation formula selected by the reward calculation formula selection circuitry.

8. A control method comprising:
acquiring state data indicating a state of a control target;
identifying a state category to which a state indicated by the state data belongs among a plurality of state categories indicating classifications of states of the control target on the basis of the state data;
calculating a reward value of a control detail for the control target on the basis of the state category and the state data; and
learning the control detail on the basis of the state data and the reward value, wherein
calculating the reward value includes selecting a reward calculation formula different for each of the plurality of state categories on the basis of the inputted state category and calculating the reward value using the selected reward calculation formula.

9. A non-transitory computer-readable storage medium storing a program for causing a computer to execute processes of:
acquiring state data indicating a state of a control target;
identifying a state category to which a state indicated by the state data belongs among a plurality of state categories indicating classifications of states of the control target on the basis of the state data;
calculating a reward value of a control detail for the control target on the basis of the state category and the state data; and
learning the control detail on the basis of the state data and the reward value,
wherein the process of calculating the reward value includes a process of selecting a reward calculation formula different for each of the plurality of state categories on the basis of the inputted state category and a process of calculating the reward value using the selected reward calculation formula.
